(19) United States
(12) Patent Application Publication
(10) Pub. No.: US 2013/0037492 A1
(43) Pub. Date: Feb. 14, 2013

(54) System and Method for Optimizing the Mixing of Hypochlorite with Ballast Water

(71) Applicants: Larry Knight, Sugar Land, TX (US); Rudolf Matousek, Richmond, TX (US); William Burroughs, Sealy, TX (US); Lucette Falcon, Houston, TX (US)

(72) Inventors: Larry Knight, Sugar Land, TX (US); Rudolf Matousek, Richmond, TX (US); William Burroughs, Sealy, TX (US); Lucette Falcon, Houston, TX (US)

(73) Assignee: SEVERN TRENT DE NORA, LLC, Sugar Land, TX (US)

(21) Appl. No.: 13/206,192

(22) Filed: Aug. 9, 2011

(51) Int. Cl. C02F 1/68

(52) U.S. Cl. 210/764; 210/198.1

(57) ABSTRACT

Systems, apparatus and methods are provided for treating ballast water by chemical injection using an injector having a geometry that minimally obstructs the ballast water flow to accomplish homogeneous mixing of hypochlorite with the ballast water within a short distance. The injector is inexpensive and has a configuration that may be easily installed and maintained.

### FIELD OF THE INVENTION

The invention relates generally to systems and methods for optimizing the mixing of hypochlorite with ballast water, and more particularly, to systems and methods for optimizing the mixing of hypochlorite with ballast water for eliminating marine species and pathogenic bacteria.

### BACKGROUND

Ballast water is used to balance the weight distribution in a marine vessel. Often ballast water is taken on at one port and transported to another where it is emptied into the new port. This common practice has an inherent danger. Discharging the ballast water taken aboard from a port in one location can be both harmful to the environment and dangerous to humans and animals in and around a port of the discharge location. Ballast water may be salt water drawn from a salt water source, such as an ocean or a sea at which port the marine vessel is docked.

The introduction of non-native marine life into a new ecosystem can have a devastating effect on the native flora and fauna which may not have natural defenses to the new species. Additionally, harmful bacterial pathogens, such as cholera, may be present in the origination port. These pathogens can multiply in the ballast tanks over time and cause an outbreak of illness in the area where they are released.

### SUMMARY

One or more embodiments of the invention provide systems, apparatus, and methods for optimizing the mixing of hypochlorite with ballast water.

One embodiment of the invention is a system for treating ballast water by chemical injection. The system comprises ballast water piping, an injector, and a mixing zone.

The ballast water piping has a main ballast line and one or more branch pipes. The branch pipes extend between the main ballast line and one or more ballast tanks.

The injector has a main header and one or more piping legs. The main header receives a means for treating ballast water. In one or more embodiments, the means for treating ballast water comprises a flow of hypochlorite. The main header comprises a top piping portion disposed above the one or more piping legs. The one or more piping legs extend from the main header and are at least partially submerged in the ballast water, the ballast water flowing through the main ballast line. The one or more piping legs may be anchored to the main ballast line for resisting ballast water-induced moment forces. The outer diameter of the piping legs is from about 0.025 m to about 0.1 m. The one or more piping legs each comprise a first portion and a second portion. The first portion extends radially from the top piping portion and the second portion is at least partially disposed inside the main ballast line and submerged in the ballast water.

A plurality of circumferential openings or perforations are disposed along the one or more piping legs. In one or more embodiments, the circumferential openings are disposed in one or more linear arrays. The circumferential openings are oriented to direct the flow of hypochlorite substantially perpendicular to the flow of ballast water at a typical velocity of about 10 m/s. The hypochlorite may flow through the circumferential openings at a velocity of from about 5 m/s to about 20 m/s.

Circumferential openings or insertion holes having a diameter from about 0.025 m to about 0.1 m may be cut into the main ballast line. The second portions of the piping legs may be inserted into the main ballast line through these circumferential openings. If the injector has a plurality of piping legs, the angle between the second portions of the piping legs is from about 30 deg. to about 90 deg.

In one or more embodiments, the injector may be constructed of a material selected from the group consisting of: titanium, Nickel-Molybdenum-Chromium alloys, non-metallic materials such as fiber-reinforced plastic or polymer (FRP), and combinations thereof.

The mixing zone comprises the ballast water piping area substantially between the injector and one or more ballast tanks. The length of the mixing zone is less than about 5 m. Within the mixing zone, the ballast water attains a concentration of at least 60% of the steady state hypochlorite concentration within the mixing zone.

Another embodiment of the invention is an apparatus for mixing hypochlorite with ballast water. The apparatus is an injector comprising a main header and one or more piping legs.

The main header receives an incoming flow of hypochlorite. The main header comprises a top piping portion disposed above the one or more piping legs. The one or more piping legs extend from the main header and are at least partially submerged in the ballast water, the ballast water flowing through the main ballast line. The one or more piping legs may be anchored to the main ballast line for resisting ballast water-induced moment forces. The outer diameter of the piping legs is from about 0.025 m to about 0.1 m. The one or more piping legs each comprise a first portion and a second portion. The first portion extends radially from the top piping portion and the second portion is at least partially disposed inside the main ballast line and submerged in the ballast water.

A plurality of circumferential openings or perforations are disposed along the one or more piping legs. In one or more embodiments, the circumferential openings are disposed in one or more linear arrays. The circumferential openings are oriented to direct the flow of hypochlorite substantially perpendicular to the flow of ballast water at a typical velocity of about 10 m/s. The hypochlorite may flow through the circumferential openings at a velocity of from about 5 m/s to about 20 m/s.

Circumferential openings or insertion holes having a diameter from about 0.025 m to about 0.1 m may be cut into the main ballast line. The second portions of the piping legs may be inserted into the main ballast line through these circumferential openings. If the injector has a plurality of piping legs, the angle between the second portions of the piping legs is from about 30 deg. to about 90 deg.

In one or more embodiments, the injector may be constructed of a material selected from the group consisting of: titanium, Nickel-Molybdenum-Chromium alloys, non-metallic materials such as FRP, and combinations thereof.

Yet another embodiment of the invention is a method of mixing hypochlorite with ballast water. The method involves providing ballast water piping and providing an injector.

The ballast water piping comprises a main ballast line and one or more branch pipes extending between the main ballast line and one or more ballast tanks.

The injector comprises a main header for receiving an incoming flow of hypochlorite. The injector further comprises one or more piping legs extending from the main header. The one or more piping legs are at least partially submerged in the ballast water. A plurality of circumferential openings or perforations are disposed along the one or more piping legs and are oriented to direct the flow of hypochlorite substantially perpendicular to the flow of ballast water. The injector is inexpensive and has a configuration that may be easily installed and maintained.

The method further involves supplying a flow of hypochlorite to the injector; directing the flow of hypochlorite outwardly through the circumferential openings; and/or mixing the hypochlorite with the ballast water.

### BRIEF DESCRIPTION OF THE DRAWINGS

FIG. 1 shows a perspective view of a hypochlorite injector in a main ballast line in accordance with one or more embodiments of the invention.

FIG. 2 shows a perspective view of a hypochlorite injector in accordance with one or more embodiments of the invention.

FIG. 3 shows a front view of a hypochlorite injector in accordance with one or more embodiments of the invention.

FIG. 4 shows a perspective view of a hypochlorite injector in accordance with one or more embodiments of the invention.

FIG. 5 shows a front view and corresponding sections views A-A and B-B of a hypochlorite injector in accordance with one or more embodiments of the invention.

FIG. 6 shows a section view of a main ballast line illustrating hypochlorite injector perforation spacing in accordance with one or more embodiments of the invention.

FIG. 7 shows a flowchart of a method in accordance with one or more embodiments of the invention.

FIG. 8 shows a perspective view of pipe geometry used for System 1 in a computational fluid dynamics (CFD) simulation.

FIG. 9 shows a table summarizing the distances between points in a pipe system used for System 1 in a computational fluid dynamics (CFD) simulation.

FIG. 10 shows a front view of a right-handed coordinate system used for System 1 in a computational fluid dynamics (CFD) simulation.

FIG. 11 shows a perspective view of cross sections at different locations of a pipe system used for System 1 in a computational fluid dynamics (CFD) simulation.

FIG. 12 shows a table summarizing distances of pipe system cross sections from the coordinate system origin used for System 1 in a computational fluid dynamics (CFD) simulation.

FIG. 13 shows a graph of minimum concentration of hypochlorite (in ppm) at various cross section planes used for System 1 in a computational fluid dynamics (CFD) simulation.

FIG. 14 shows a graph of cross section area (in percent of total cross section area) with a mixing fraction of hypochlorite greater than 2, 4, 6, 8 and 10 ppm used for System 1 in a computational fluid dynamics (CFD) simulation.

FIG. 15 shows a perspective view of generalized geometry used for System 2 in computational fluid dynamics (CFD) simulations.

FIG. 16 shows a perspective view of generalized geometry used for System 3 in computational fluid dynamics (CFD) simulations.

FIG. 17 shows a side and front view of the coordinate system used for System 2 and System 3 in computational fluid dynamics (CFD) simulations.

FIG. 18 shows a graph of minimum concentration of hypochlorite (in ppm) at various cross section planes used for System 2 in a computational fluid dynamics (CFD) simulation.

FIG. 19 shows a graph of cross section area (in percent of total cross section area) with a mixing fraction of hypochlorite greater than 8, 10 and 12 ppm used for System 2 in a computational fluid dynamics (CFD) simulation.

FIGS. 20A-20B shows a graph of minimum concentration of hypochlorite (in ppm) at various cross section planes used for System 3 in a computational fluid dynamics (CFD) simulation.

FIGS. 21A-21B shows a graph of cross section area (in percent of total cross section area) with a mixing fraction of hypochlorite greater than 2, 4, 6, 8 and 10 ppm used for System 3 in a computational fluid dynamics (CFD) simulation.

### DETAILED DESCRIPTION OF THE INVENTION

Hypochlorite is often used to disinfect ballast water drawn onboard a ship for ballast tanks. When hypochlorite is used in this manner, its disinfection efficacy depends on how well the hypochlorite is mixed with the ballast water. Typically, one end of a hypochlorite line is connected to a receptacle containing hypochlorite (i.e., a hypochlorite source). Electrolytic cells, for example, may be used to generate hypochlorite. The other end of the hypochlorite line is connected to the main ballast line. Hypochlorite flows from the hypochlorite-containing receptacle through the hypochlorite line to the main ballast line.

In very low ballast water flow rates (e.g., less than 500 m³/h), the main ballast line has a small enough diameter (e.g., about 0.2 m) that the injected hypochlorite may mix well with the ballast water simply using a single straight or curved pipe. However, these types of injectors do not provide adequate mixing when used with main ballast lines having a larger diameter (e.g., about 0.8 m) and higher ballast water flow rates (e.g., 5,000 m³/h).

Besides inadequate mixing, conventional injectors used in various applications (including those beyond the scope of ballast water disinfection) may possess other undesirable characteristics. For example, the geometry of some injectors is such that the injectors may create an undue obstruction to ballast water flow, limiting flow rate and thus ballast water throughput to ballast tanks. Other injectors may lack rigidity to effectively counter the moment forces acting on the injectors produced by the ballast water flow.

Among the issues presented when disinfecting ballast water with hypochlorite is the challenge of introducing the hypochlorite into the ballast water considering their respective concentrations and flow rates. The bulk flow of hypochlorite being injected may only account for approximately 1% of the ballast water it is going into, and the injection nozzle flow rate may be less than 1% of the ballast water flow rate.

FIG. 1 illustrates a system 100 for optimizing the mixing of hypochlorite with ballast water. The system 100 comprises a hypochlorite injector 104 at least partially submerged in ballast water flowing through a main ballast line 108. In one or more embodiments, the inside diameter of the main ballast line 108 may be from about 0.1 m to about 1.0 m.

Ballast water flows through the main ballast line 108 towards one or more ballast tanks (not shown). The ballast water flow is directed into one or more branch pipes 112, which lead to the ballast tanks. The branch pipes 112 are connected to the main ballast line 108 and may be disposed substantially perpendicular to the main ballast line 108. A valve 116 may be disposed in the branch pipes 112 and kept in the open position during ballasting operations. In one or more embodiments, valve 116 may be a butterfly valve.

The distance between the hypochlorite injector 104 and the branch pipes 112 may vary. However, in one or more embodiments the distance between the hypochlorite injector 104 and the branch pipes 112 may be as short as 10 m. Hypochlorite injected via the hypochlorite injector 104 mixes with the ballast water flowing through main ballast line 108, and the distance between the hypochlorite injector 104 and the branch pipes 112 represents a mixing zone 120. In one or more embodiments, the hypochlorite injector 104 may be constructed of titanium. In other embodiments, the hypochlorite injector 104 may be constructed of any Nickel-Molybdenum-Chromium Alloy or any other non-metallic materials such as FRP. However, any material or combination of materials suitable for the construction of the hypochlorite injector 104 to optimize the mixing of hypochlorite with ballast water may be used. Moreover, different materials may be used to construct each of the hypochlorite injector 104 and the main ballast line 108.

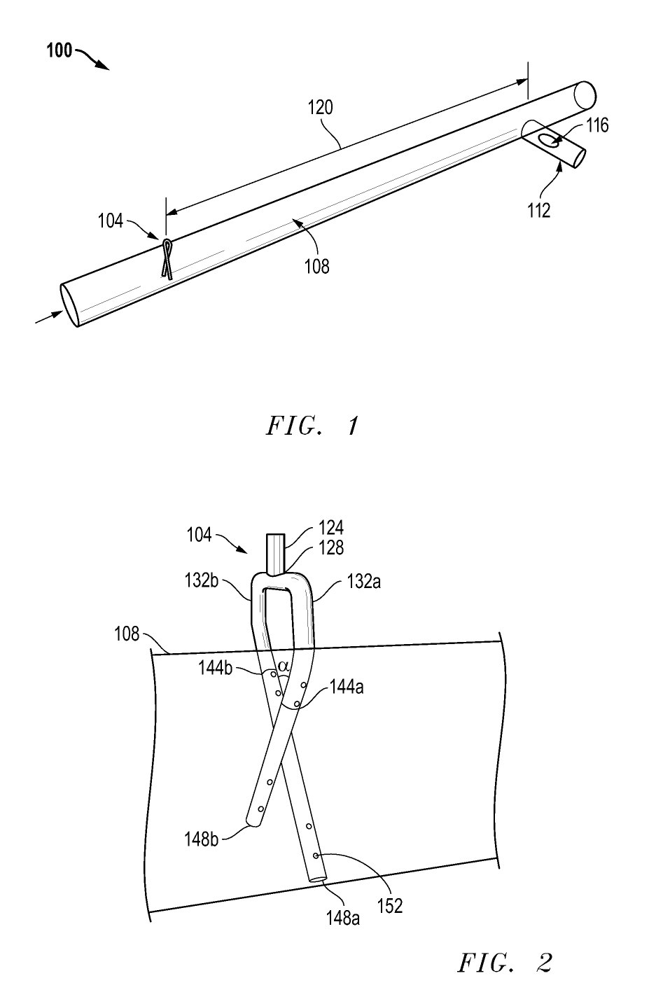

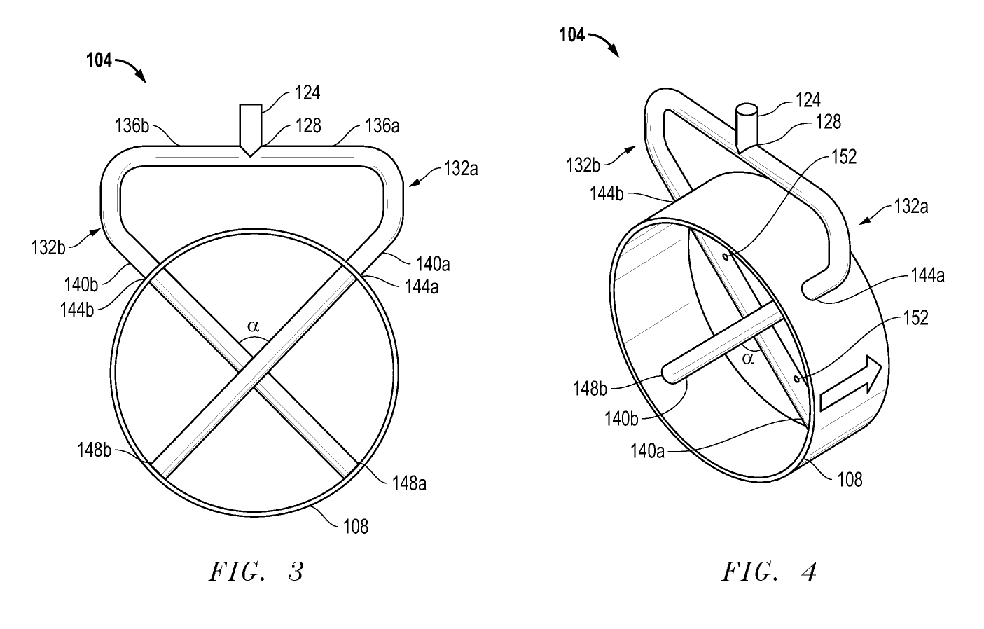

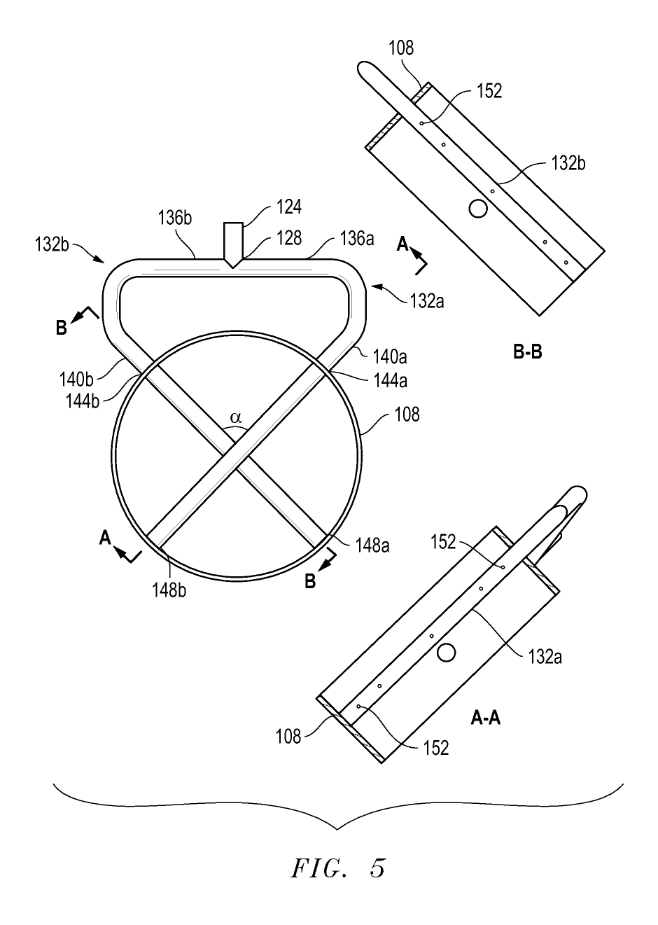

Referring to FIGS. 2-5, the hypochlorite injector 104 is shown in accordance with one or more embodiments of the present invention. The hypochlorite injector 104 may comprise a top piping portion 124 and a ‘T’-junction 128 at which two piping legs 132a, 132b branch out. The two piping legs 132a, 132b each may have a first portion 136a, 136b extending radially from the top piping portion 124 such that the first portions 136a, 136b are substantially perpendicular to the top piping portion 124. The top piping portion 124 and the first portions 136a, 136b of the two piping legs 132a, 132b all meet at ‘T’-junction 128.

The piping legs 132a, 132b of the hypochlorite injector 104 each may also have a second portion 140a, 140b. The second portions 140a, 140b may be at least partially submerged within the ballast water flowing through the main ballast line 108. A first pair of insertion holes 144a, 144b ranging in diameter from about 0.025 m to about 0.1 m may be cut into the main ballast line 108 in order to insert the second portions 140a, 140b of the piping legs 132a, 132b. Viewed from the front, as illustrated in FIG. 3, the second portions 140a, 140b together may form a crossbar or an ‘X’-shape.

The angle a between the second portions 140a, 140b of the piping legs 132a, 132b may be from about 30 deg. to about 90 deg. In one or more embodiments, the angle α between the second portions 140a, 140b is 90 deg., as shown in FIGS. 2-5. The second portions 140a, 140b of the piping legs 132a, 132b may be spaced apart as illustrated in cross sections A-A and B-B of FIG. 5 to account for potential fluid forces exerted on the hypochlorite injector 104 by ballast water flow. This eliminates a contact area which minimizes any wear of the crossing pipe network.

The two piping legs 132a, 132b may each have an end portion 148a, 148b. In one or more embodiments, the end portions 148a, 148b may be in contact with and pressed against the inside surface of the main ballast line 108 such that the two piping legs 132a, 132b are anchored to the main ballast line 108. The end portions 148a, 148b may be spring loaded or biased towards the inside surface of the main ballast line 108 against which the end portions 148a, 148b are pressed. Biasing the end portions 148a, 148b towards the inside surface of the main ballast line 108 may compensate for any differences in thermal expansion which may result, particularly if the hypochlorite injector 104 and the main ballast line 108 are constructed of different materials. Flanges (not shown) may be utilized to connect the second portions 140a, 140b to the first portions 136a, 136b of the piping legs 132a, 132b. A gap between the flanges (not shown) being joined may be present when using spring loaded or biased end portions 148a, 148b. Bolts (not shown) may be used to fasten the flanges (not shown) being joined. As the bolts are tightened, the spring (not shown) may be compressed, creating the desired contact force on the end portions 148a, 148b of the piping legs 132a, 132b against the inside surface of the main ballast line 108. In one or more embodiments, Belleville disc springs may be used to spring load or bias the end portions 148a, 148b of the piping legs 132a, 132b towards the inside surface of the main ballast line 108. However, in other embodiments, any type of spring or biasing member suitable for spring loading or biasing the end portions 148a, 148b of the piping legs 132a, 132b towards the inside surface of the main ballast line 108 may be used.

Alternatively, or additionally, a sealant and/or an adhesive may be applied to the location at which the piping legs 132a, 132b intersect the main ballast line 108 (i.e., the area at which the piping legs 132a, 132b are in contact with first insertion holes 144a, 144b). In one or more embodiments, the piping legs 132a, 132b may be welded to the main ballast line 108 at the area in which the piping legs 132a, 132b are in contact with first insertion holes 144a, 144b.

In other embodiments, the two piping legs 132a, 132b may be anchored to the main ballast line 108 by disposing the end portions 148a, 148b through a second pair of insertion holes (not shown) cut at the bottom of the main ballast line 108. The second pair of insertion holes may range in diameter from about 0.025 m to about 0.1 m. Thus, the end portions 148a, 148b may protrude outwardly from the outside surface of the main ballast line 108. A flange (not shown) may be disposed at each of the end portions 148a, 148b such that the flange abuts the outside surface of the main ballast line 108. The flange may be larger in size than the second pair of insertion holes from which the end portions 148a, 148b extend so that the flange may restrict the end portions 148a, 148b from moving towards the inside of the main ballast line 108. Similarly, flanges (not shown) may be disposed abutting the outside surface of the main ballast line 108 proximate first insertion holes 144a, 144b and opposite the flanges disposed at the end portions 148a, 148b.

Anchoring the two piping legs 132a, 132b to the main ballast line 108 may serve to resist moment forces produced by the ballast water flowing past the hypochlorite injector 104.

The hypochlorite injector 104 may further comprise a plurality of perforations 152 disposed along the second portions 140a, 140b of the piping legs 132a, 132b. In one or more embodiments, the perforations 152 are arranged in a linear array pattern such that the hypochlorite flowing through the hypochlorite injector 104 may exit the perforations 152 radially with respect to the second portions 140a, 140b of the piping legs 132a, 132b. The number of perforations 152 and their spacing may vary according the particular application. Hypochlorite exiting the perforations 152 may flow substantially perpendicular to the flow of ballast water in the main ballast line 108, facilitating the thorough mixing of hypochlorite with ballast water.

In one or more embodiments, the perforations 152 may have a minimum diameter of 4 mm to substantially reduce or prevent clogging due to any precipitates that may have been produced during hypochlorite generation. The number of perforations 152 may be determined using the expression 8N+4. The target fluid velocity through the perforations 152 is 10 m/s. It follows that the minimum flow through the piping legs 132a, 132b of the hypochlorite injector 104 is (1.81+3.62 N) m³/hr. The hypochlorite may flow through the perforations at a velocity of from about 5 m/s to about 20 m/s.

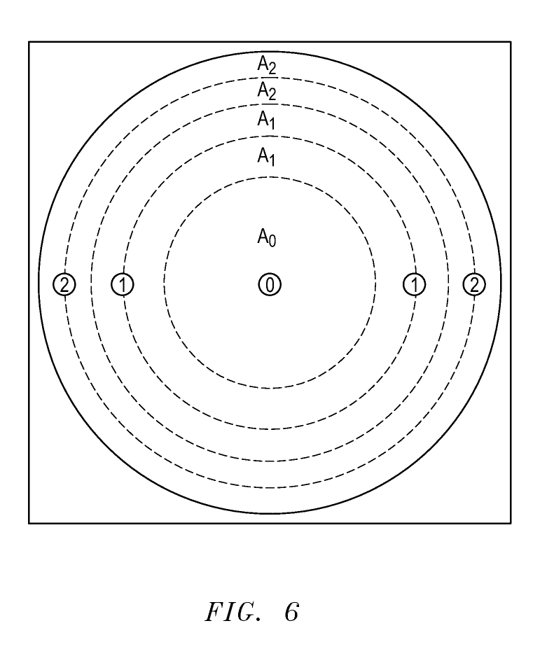

FIG. 6 illustrates perforations 152 along one side of a single piping leg 132a as viewed from a cross section of the main ballast line 108. Where N=2, the total number of perforations in the hypochlorite injector 104, according to the expression 8N+4, is 20. Therefore, each of piping legs 132a, 132b comprises 10 perforations 152, which are distributed equally among two opposing sides (i.e., 5 perforations 152 on each of two sides). FIG. 6 illustrates 5 perforations 152 (labeled 0, 1 (×2), and 2 (×2)) as they are distributed equally among opposing sides of each of piping legs 132a, 132b. The perforations 152 may be modeled to dose concentric rings (labeled A₀, A_{1,} A_{1,} A₂ and A₂) in a cross section of the main ballast line 108. Since the area between equally spaced concentric rings increases linearly with respect to diameter, either the spacing between perforations 152 must decrease or the perforations must become larger as the distance from the centerline of the main ballast line 108 increases. FIG. 6 shows perforations 152 of a fixed size that are decreasingly spaced apart as the distance from the centerline of the main ballast line 108 increases. The area served by the perforation labeled 0 is A₀; the area served by the two perforations labeled 1 are the two areas labeled A₁; and the area served by the two perforations labeled 2 are the two areas labeled A₂.

The size of the perforations 152 may depend on the total number of perforations 152. A value of N may be selected for a given hypochlorite injector 104, which may be used to determine the total number of perforations according to the expression 8N+4. The total area required for an average velocity of 10 m/s may be calculated. The total area may be divided by the total number of perforations 152 in order to determine the area of a single perforation 152. Subsequently, the area of a single perforation 152 may be used to determine the diameter of a single perforation 152, and a standard drill bit size that substantially matches the diameter may be used as the perforation 152 size.

Although the description above with reference to FIG. 6 describes the perforations 152 as all being the same size, other embodiments may comprise a hypochlorite injector 104 having perforations 152 of various sizes.

Thus, to optimize the mixing of hypochlorite with ballast water, hypochlorite flows from a hypochlorite-containing receptacle (not shown) to the hypochlorite injector 104. The hypochlorite enters the top piping portion 124 of the hypochlorite injector 104 and flows downwards to ‘T’-junction 128, where the hypochlorite flow branches out radially (with respect to the top piping portion 124) into the first portions 136a, 136b of the piping legs 132a, 132b. Subsequently, the hypochlorite flows into the second portions 140a, 140b of the piping legs 132a, 132b and out of the hypochlorite injector 104 via perforations 152.

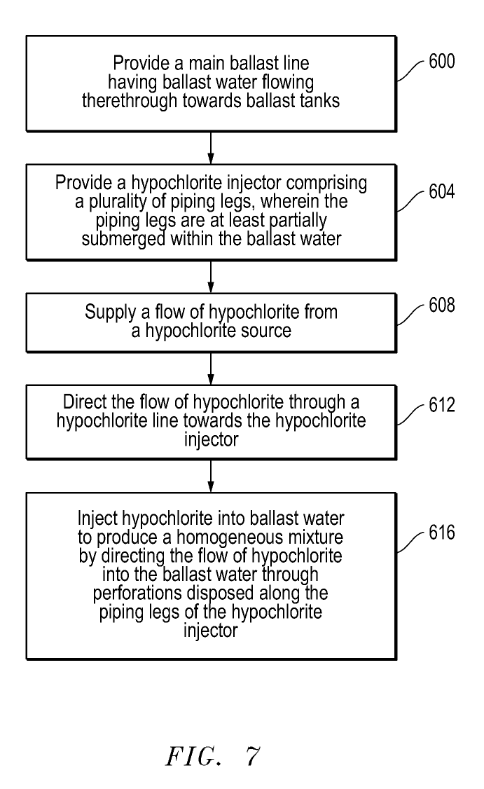

One or more embodiments of the present invention relate to methods for enhanced mixing of fluids, as shown by the flow chart in FIG. 7. The methods involve providing a main ballast line comprising ballast water flowing therethrough towards ballast tanks 600; providing a hypochlorite injector comprising a plurality of piping legs, wherein the piping legs are at least partially submerged within the ballast water 604; supplying a flow of hypochlorite from a hypochlorite source 608; directing the flow of hypochlorite through a hypochlorite line towards the hypochlorite injector 612; and injecting hypochlorite into the ballast water to produce a homogeneous mixture by directing the flow of hypochlorite into the ballast water through perforations disposed along the piping legs of the hypochlorite injector 616.

### Computational Fluid Dynamics (CFD) Results

In order to determine the required pipe length for homogenous mixing of ballast water and hypochlorite in the main ballast line, computational fluid dynamics (CFD) simulations were conducted for varying main ballast line sizes and ballast water flow rates. Ballast water flow rates between 200 and 5000 m³/h were chosen to comply with guidance on scaling of ballast water management systems.

CFD methods are well accepted, widely used tools in industry to solve fluid dynamics problems. The simulation of complex pipe mixing processes with Reynolds averaged Navier-Stokes (RANS) equations are common practice in industry. Unlike model tests, numerical methods give access to all flow variables at any point within the simulation domain.

Various configurations were studied to determine the required mixing zone to ensure homogeneous mixing of hypochlorite with ballast water for varying size and flow rate.

System 1 was modeled after a conventional system that has previously passed shipboard testing. Dimensions and flow data of the installed system served as input parameters for the CFD simulation. As illustrated in FIG. 8, System 1 comprises a main ballast line having nine elbows with a ballast water flow rate of about 200 m³/h. The injection pipe of the hypochlorite solution connects to the main ballast line without an injection nozzle. Between elbow one and two is a butterfly valve. The butterfly valve is in an open position. The right-handed coordinate system used in the simulation has its origin at elbow one after the injection pipe, as illustrated in FIG. 10.

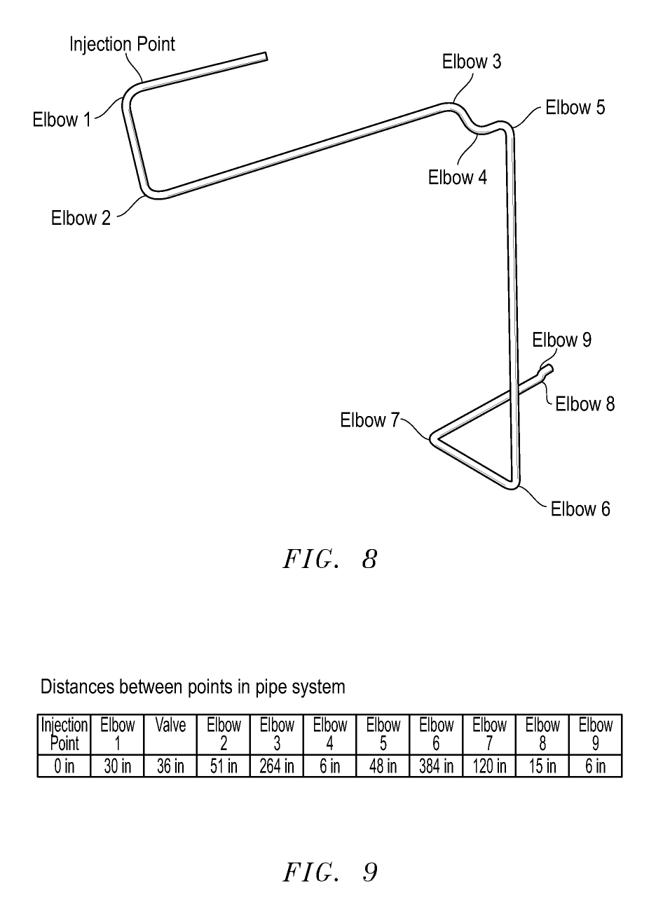

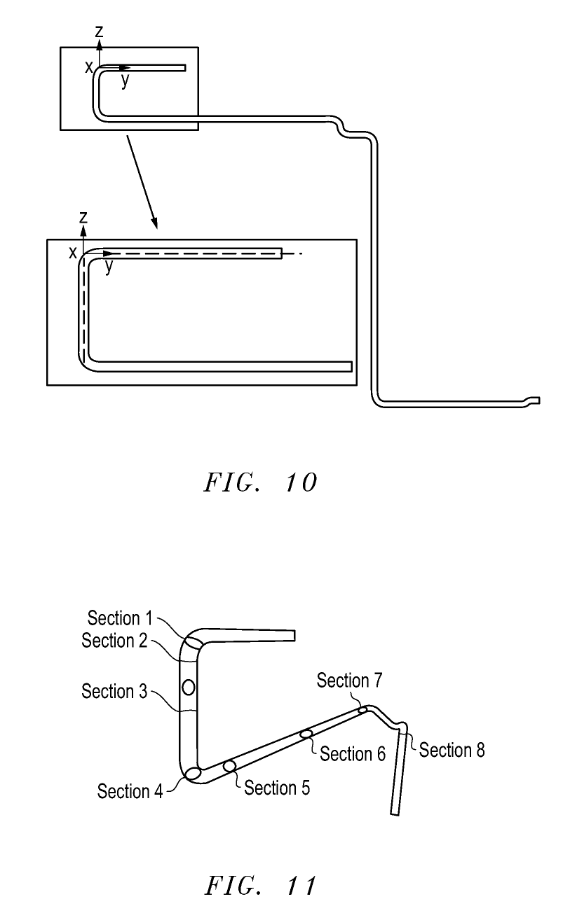

FIG. 9 shows a table that gives the distances between the injection point, the elbows and the valve. For data evaluation of the simulation results, various cross sections were created at different locations, as illustrated in FIGS. 11-12.

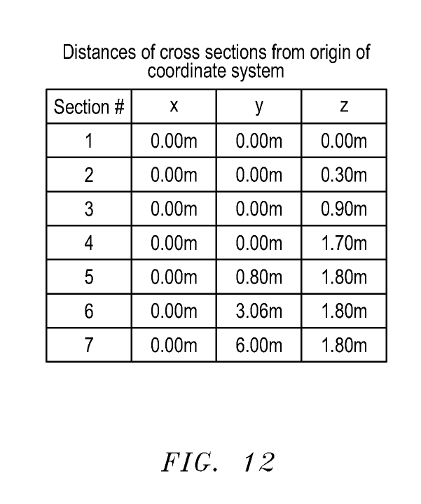

FIG. 13 is a graph showing the minimum concentration of hypochlorite in parts per million (ppm) at the cross section planes of the CFD simulation. As used herein, the term “minimum concentration of hypochlorite” means that the concentration of hypochlorite is not less than the specified value (in ppm) at any point in the specified plane.

The cross section area where the fraction of hypochlorite is more than 2, 4, 6, 8 and 10 ppm, is shown in FIG. 14 (in percent of the total cross section area).

At section 6 after the second elbow (4.86 m after the injection point), the minimum concentration is above 10 ppm for the complete cross section area. At section 4 (1.7 m after the injection point), already more than 80% of the cross section area is mixed with more than 8 ppm of hypochlorite. Homogeneous mixing is reached (i.e., 100% of the cross section area is mixed at or above 8 ppm) between section 5 and 6 at a distance of 2.98 m from the injection point.

Although System 1 verifies effective mixing of hypochlorite with ballast water, such systems are not always practical as they may be costly and/or require too much space on a ship.

Thus, System 2 and System 3 model systems having a straight main ballast line, rather than one having several elbows, tees, or valves to facilitate mixing, using a hypochlorite injector. This arrangement would be applicable, for example, where the hypochlorite is injected in the cargo section of the ship, after the pump room.

System 2 utilizes a single curved pipe as a hypochlorite injector modeled after a conventional system whereas System 3 utilizes a hypochlorite injector in accordance with one or more embodiments of the present invention described above.

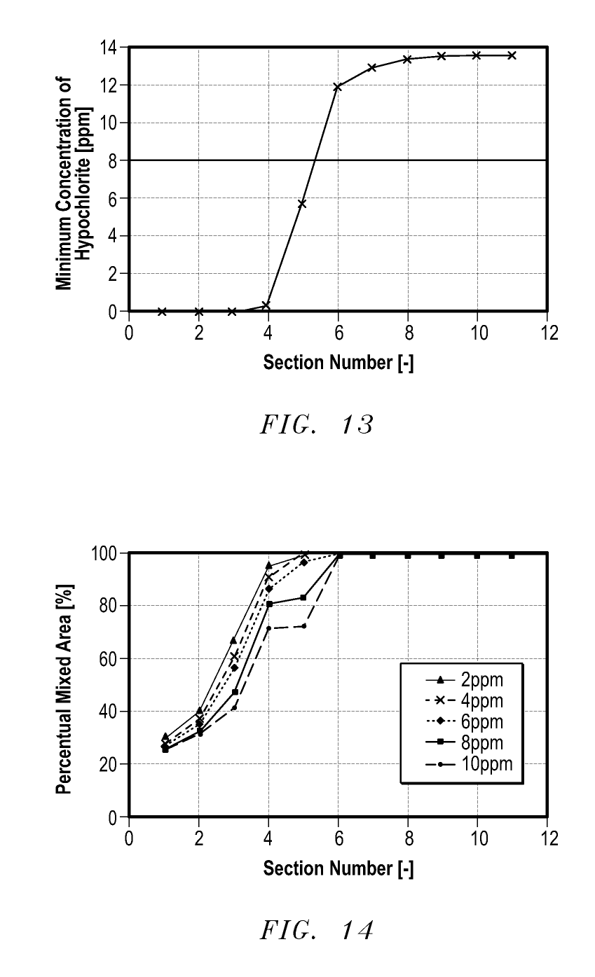

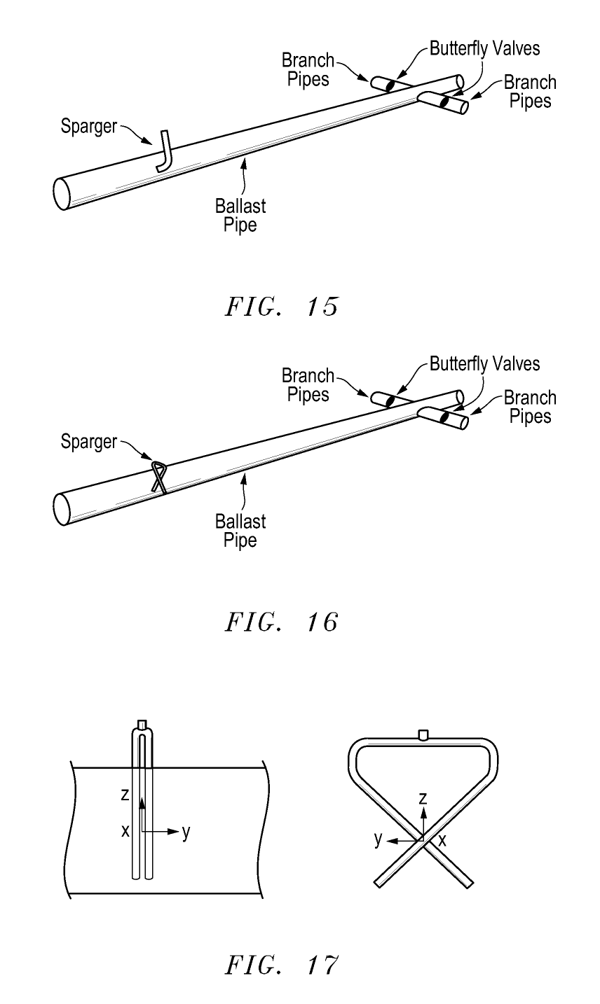

To determine the required pipe length for homogeneous mixing at higher flow rates, the CFD simulations of System 2 and System 3 were conducted for a generalized geometry with different hypochlorite injectors, as illustrated in FIG. 15 and FIG. 16, respectively. The main ballast line was assumed as a straight pipe after the injection of the hypochlorite. The flow then is split into two branch pipes which go to the ballast water tanks. Within each branch pipe a butterfly valve is assumed, which stands in an open position. The purpose of using this particular geometry was to simulate a type of worst case scenario where piping is the shortest distance to the closest ballast tanks, i.e., 10 m from injection point to branch pipe and 1 m from branch take-off to butterfly valve right before tank entry. The main ballast line was extended 2 m after the branch.

FIG. 17 shows the right-handed coordinate system used for System 2 and System 3. The origin is located in the centerline of the main ballast line and in the centerline of the injector. The x-axis points in the direction of the main ballast flow and the z-axis towards the injection flow. Various cross sections were uniformly distributed between the injector and the branch pipe. The volume meshes for the CFD simulations consisted of 6 to 10 million control volumes.

System 2 and System 3, which involve a main ballast line flow rate of 4,960 m³/h, may be used as representative examples of systems involving high flow rates.

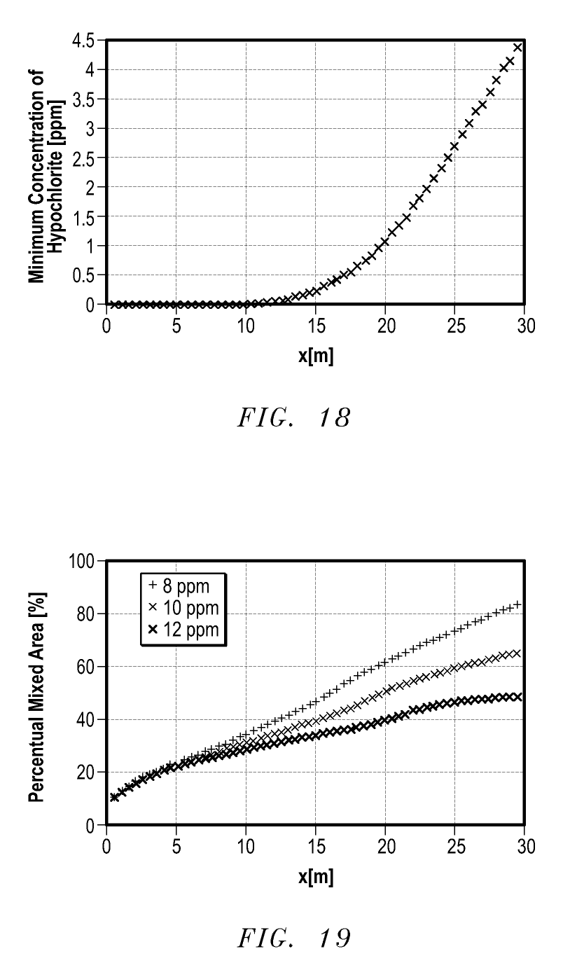

FIGS. 18-19 relate to System 2. FIG. 18 plots the minimum concentration of hypochlorite in ppm at selected section planes. FIG. 19 illustrates the cross section area (in percent of total cross section area) with a mixing fraction of hypochlorite greater than 8, 10 and 12 ppm.

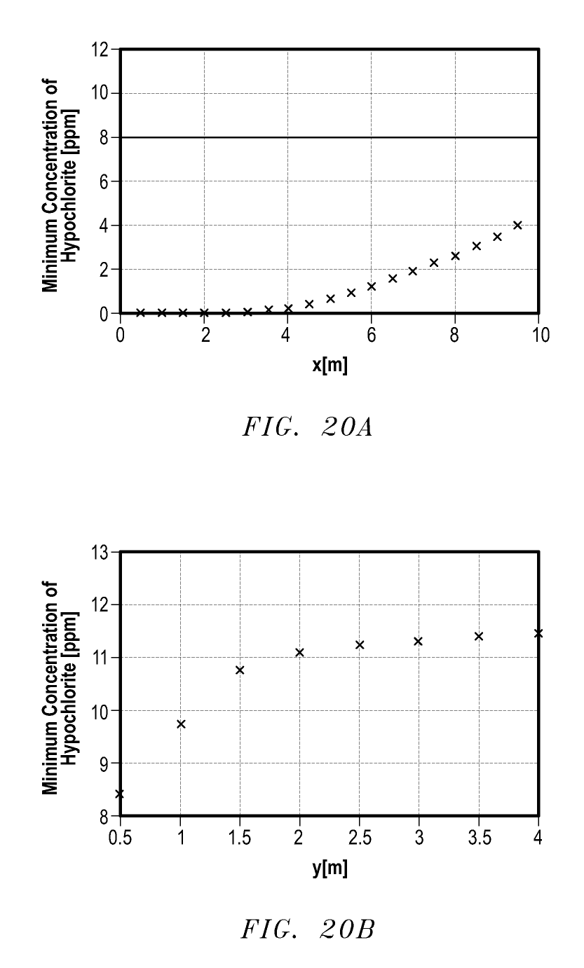

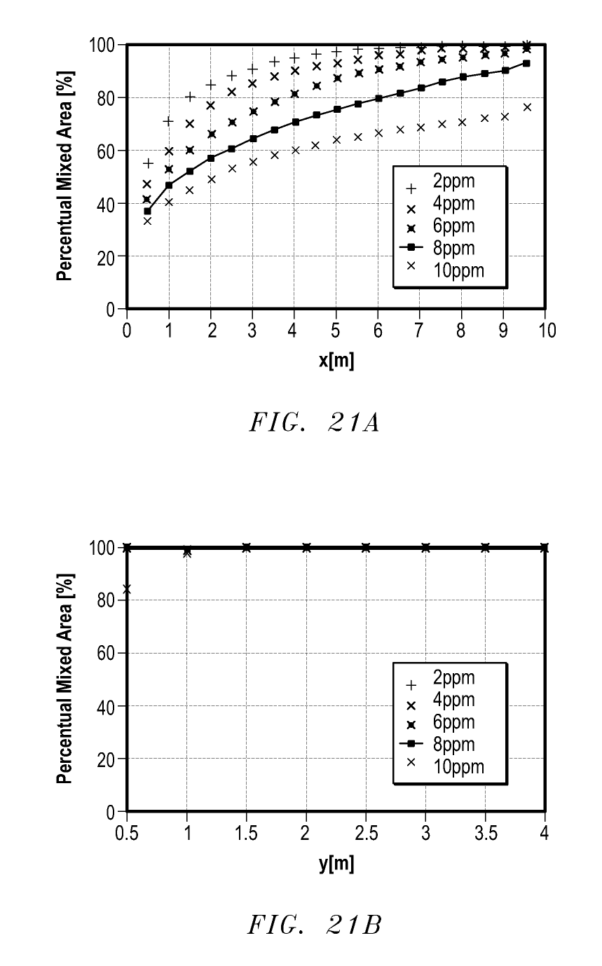

FIGS. 20A-20B and 21A-21B relate to System 3. FIGS. 20A-20B plots the minimum concentration of hypochlorite in ppm at selected section planes. FIGS. 21A-21B illustrates the cross section area (in percent of total cross section area) with a mixing fraction of hypochlorite greater than 2, 4, 6, 8 and 10 ppm.

The hypochlorite injector of System 2, modeled after a conventional system, requires about 12 m of pipe length (main ballast line) to achieve 40% of the stream having a hypochlorite concentration at or above 8 ppm. More than 30 m of pipe length is required to achieve 100% of the stream having a hypochlorite concentration at or above 8 ppm.

In contrast, the hypochlorite injector of System 3, in accordance with one or more embodiments of the present invention, requires less than 1 m to achieve 40% of the stream having a hypochlorite concentration at or above 8 ppm. At about 10.5 m from the injection point, System 3 achieves 100% of the stream having a hypochlorite concentration at or above 8 ppm. At about 11 m from the injection point, System 3 achieves 100% of the stream having a hypochlorite concentration at or above 10 ppm.

Accordingly, System 3 verifies effective homogeneous mixing of hypochlorite with ballast water, achieving a desirable minimum hypochlorite concentration from about 10 ppm to about 12 ppm before reaching the ballast water tanks.

Thus, embodiments of the present invention may accomplish homogeneous mixing of hypochlorite with ballast water within a short distance. The geometry of the hypochlorite injector minimally obstructs ballast water flow, compared to other injector geometries which can greatly hinder flow rates. The hypochlorite injector legs may be anchored to the main ballast line, improving rigidity of embodiments of the system by facilitating the resistance of moment forces produced by the ballast water flow. Further improving the rigidity of embodiments of the system, the legs of the hypochlorite injector may be spaced apart from each other such that fluid forces exerted on the injector by ballast water flow do not cause the legs to collide with each other. Moreover, the geometry and positioning of the hypochlorite injector may facilitate access for retrofitting. Rather than having to completely cut transversely through the main ballast line (or otherwise undesirably degrade its integrity) for installation and/or removal, the hypochlorite injector of embodiments of the present invention simply requires that relatively small insertion holes be cut into the main ballast line. The hypochlorite injector, with its simple installation, is a very inexpensive solution to enhance liquid chemical injection and mixing with fluid in a pipe.

While the foregoing describes various embodiments of the invention, other and further embodiments of the invention may be devised without departing from the basic scope thereof. For example, a hypochlorite injector in accordance with one or more embodiments of the invention may comprise more than two piping legs extending from a common header. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

We claim:

1. A system for treating ballast water by chemical injection, the system comprising:
ballast water piping, comprising:
a main ballast line; and
one or more branch pipes extending between the main ballast line and one or more ballast tanks;
an injector, comprising:
a main header for receiving a means for treating ballast water;
one or more piping legs extending from the main header, the one or more piping legs at least partially submerged in the ballast water, the ballast water flowing through the main ballast line, wherein the one or more piping legs have a plurality of circumferential openings; and
a mixing zone comprising the ballast water piping area substantially between the injector and the one or more ballast tanks.

2. The system of claim 1, wherein the means for treating ballast water is a flow of hypochlorite.

3. The system of claim 2, wherein the plurality of circumferential openings are oriented to direct the flow of hypochlorite substantially perpendicular to the flow of the ballast water.

4. The system of claim 1, wherein the piping legs are anchored to the main ballast line for resisting ballast water-induced moment forces.

5. The system of claim 1, the main header comprising a top piping portion, the top piping portion disposed above the one or more piping legs and having a longitudinal axis oriented substantially vertical.

6. The system of claim 1, the mixing zone comprising a length of less than about 5 m.

7. The system of claim 6, wherein the ballast water attains a concentration of at least 60% of the steady state hypochlorite concentration within the mixing zone.

8. An injector for mixing hypochlorite with ballast water, the injector comprising:
a main header for receiving an incoming flow of hypochlorite; and
one or more piping legs extending from the main header, the one or more piping legs at least partially submerged in the ballast water, the ballast water flowing through a main ballast line, the one or more piping legs having a plurality of circumferential openings oriented to direct the flow of hypochlorite substantially perpendicular to the flow of ballast water.

9. The injector of claim 8, the hypochlorite flowing through the circumferential openings at a velocity of from about 5 m/s to about 20 m/s.

10. The injector of claim 8, the main header comprising a top piping portion, the top piping portion disposed above the one or more piping legs and having a longitudinal axis oriented substantially vertical.

11. The injector of claim 10, the one or more piping legs each comprising a first portion and a second portion, the first portion extending radially from the top piping portion, the second portion at least partially disposed inside the main ballast line and submerged in the ballast water.

12. The injector of claim 11, wherein the angle between the second portions of the piping legs is from about 30 deg. to about 90 deg. on the condition that the injector comprises a plurality of piping legs.

13. The injector of claim 12, wherein the piping legs are anchored to the main ballast line for resisting ballast water-induced moment forces.

14. The injector of claim 8, wherein the plurality of circumferential openings are disposed in one or more linear arrays.

15. The injector of claim 8, wherein the outer diameter of the piping legs is from about 0.025 m to about 0.1 m.

16. The injector of claim 8, wherein the injector is constructed of a material selected from a group consisting of: titanium, Nickel-Molybdenum-Chromium alloys, non-metallic materials, and combinations thereof.

17. A method of mixing hypochlorite with ballast water, the method comprising:
providing ballast water piping, comprising:
a main ballast line; and
one or more branch pipes extending between the main ballast line and one or more ballast tanks;
providing an injector comprising:
a main header for receiving an incoming flow of hypochlorite;
one or more piping legs extending from the main header, the one or more piping legs at least partially submerged in the ballast water, wherein the one or more piping legs have a plurality of circumferential openings oriented to direct the flow of hypochlorite substantially perpendicular to the flow of ballast water.

18. The method of claim 17 further comprising supplying a flow of hypochlorite to the injector.

19. The method of claim 18 further comprising directing the flow of hypochlorite outwardly through the circumferential openings.

20. The method of claim 19 further comprising mixing the hypochlorite with the ballast water.
